(19) United States
(12) Patent Application Publication
(10) Pub. No.: US 2015/0335999 A1
(43) Pub. Date: Nov. 26, 2015

(54) FACILITATING THE COLLABORATION OF PLAYERS IN AN ONLINE GAME

(71) Applicant: DeNA Co., Ltd., Tokyo (JP)

(72) Inventors: Yuji SHIMIZU, Tokyo (JP); Nobyshi FUJIMORI, Tokyo (JP); Kazuhiro KONDO, Tokyo (JP)

(73) Assignee: DeNA Co., Ltd., Tokyo (JP)

(21) Appl. No.: 14/284,338

(22) Filed: May 21, 2014

(51) Int. Cl. A63F 13/30; A63F 13/60

(52) U.S. Cl. CPC A63F 13/30; A63F 13/60

(57) ABSTRACT

Systems and methods for facilitating the collaboration of players in an online game are described. In some embodiments, the systems and methods determine a first player of the online game has reached a zero lives status within a game instance of the online game, select a second player of the online game according to a predetermined selection criteria, and provide the second player with access to the game instance of the online game at a stage within the game instance that corresponds to a stage at which the first player reached the zero lives status.

### BACKGROUND

Video games are popular pastime activities. In the past, video games were played on arcade machines, televisions, and computers. More recently, video games are played on portable devices, such as mobile phones and tablets. The video games that are played on portable or mobile devices are sometimes referred to as “mobile video games,” or “online games.” The portable devices (e.g., mobile devices) typically include a touch sensitive display area (e.g., a touchscreen) by which players can view presented video games, provide input to control game actions with the games, navigate options presented by the games, and perform other actions.

Current online games, such as those played using mobile devices, offer a variety of different game environments and accompanying activities to engage current and new players with the games. For example, an online game may enable a player to play a game with friends or other players, may enable a player to compete with friends or other players for rewards and other incentives, and may incentivize the player to introduce the online game to friends of the player that do not play the game. The providers of online games, therefore, constantly implement new games, new game activities, and new game incentives in order to increase the number of people playing their games and engage with the current players of their games.

### SUMMARY

Systems and methods for facilitating the collaboration of players in an online game are described. In some embodiments, the systems and methods determine a first player of the online game has reached a zero lives status within a game instance of the online game, select a second player of the online game according to a predetermined selection criteria, and provide the second player with access to the game instance of the online game at a stage within the game instance that corresponds to a stage at which the first player reached the zero lives status.

In some embodiments, the systems and methods include a player status module that determines a first player of the online game has reached a zero lives status within a game instance of the online game, a player selection module that selects a second player of the online game according to a predetermined selection criteria, and a game access module that provides the second player with access to the game instance of the online game at a stage within the game instance that corresponds to a stage at which the first player reached the zero lives status.

The systems and methods may also include a game character module that identifies a character used by the first player when playing the game instance of the online game and assigns the identified character used by the first player to the second player for use in the game instance of the online game, and/or a game reward module that determines that the second player of the game instance has completed a stage within the game instance not reached by the first player and provides a reward within the online game to the first player and the second player that is based on the completion of the stage by the second player.

In some embodiments, the systems and methods determine that a player of an online game has reached an end game status within a game instance of the online game, identify a friend of the player within the online game that has played a previous instance of the online game, and provide the friend with access to the game instance of the online game at a stage corresponding to a stage at which the player reached the end game status within the game instance.

### BRIEF DESCRIPTION OF THE DRAWINGS

FIG. 1 is a block diagram illustrating a suitable computing environment for facilitating the collaboration of players in an online game.

FIG. 2 is a block diagram illustrating the components of a game collaboration system.

FIG. 3 is a flow diagram illustrating a method for providing a second player of an online game with access to a game instance of a first player of the online game.

FIG. 4A is a flow diagram illustrating a method for selecting a member of a social network as a collaborator.

FIG. 4B is a flow diagram illustrating a method for selecting another player of an online game as a collaborator.

FIG. 5 is a flow diagram illustrating a method for providing a character to be used by a collaborator in an online game.

FIGS. 6A-6B are flow diagrams illustrating methods for rewarding players of an online game.

FIG. 7 is a block diagram illustrating a communications system.

FIG. 8 is a block diagram illustrating the components of a server.

FIG. 9 is a block diagram illustrating a user device and/or user system.

### DETAILED DESCRIPTION

Systems and methods for facilitating the collaboration of players in an online game are described. As described herein, the systems and methods, via a game collaboration system, may determine a first player of the online game has reached a zero lives status within a game instance of the online game, select a second player of the online game according to a predetermined selection criteria, and provide the second player with access to the game instance of the online game at a stage within the game instance that corresponds to a stage at which the first player reached the zero lives status.

The game collaboration system, therefore, may enable a game provider to realize an engaging and compelling game experience for its players by encouraging and facilitating collaboration between two players (e.g., two friends) when playing an online game. Also, the game provider may utilize the game collaboration system when introducing new players to an online game, providing the new players with various different access points to the game and enabling the new players to act as collaborators with other players of the online game, among other benefits.

### Examples of a Suitable Computing Environment

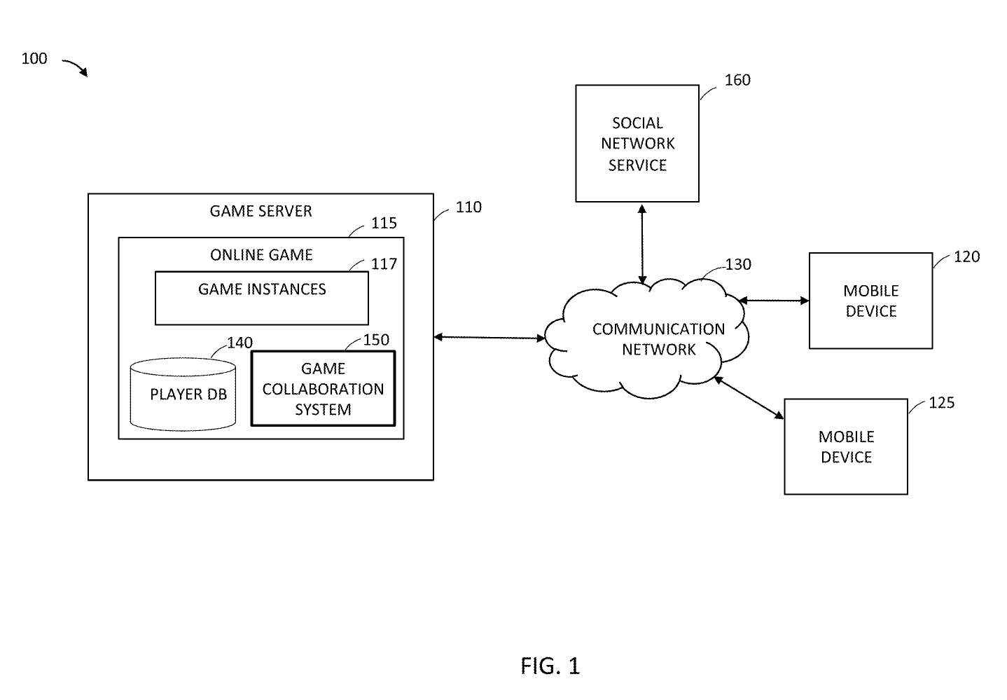

FIG. 1 is a block diagram illustrating a suitable computing environment 100 for facilitating the collaboration of players in an online game. The computing environment 100 includes a game server 110 that may support and provide one or more online games 115 to players, such as players at mobile devices 120, 125 that communicate with the game server 110 over a communication network 130 in order to access and provide the online games 115 to the players. For example, players associated with the mobile devices 120, 125 may stream the online games 115 from the game server 110 when playing games, or may download a mobile application (e.g., an “app”) to the mobile devices 120, 125 and play game via the mobile application in an online or offline scenario.

The communication network 130 may be any network that enables communication between or among servers, machines, databases, and/or devices. Accordingly, the network 130 may be a wide access network (WAN), wired network, a fiber network, a wireless network (e.g., a mobile or cellular network), a cellular or telecommunications network (e.g., WiFi, Global System for Mobile Communications (GSM), Universal Mobile Telecommunications System (UMTS), Long Term Evolution (LTE) network), or any suitable combination thereof. The communication network 130 may include one or more portions of a private network, a public network (e.g., the Internet), or any suitable combination thereof.

The mobile devices 120, 125 may be any type of user device capable of communicating with the game server 110 over the network 130 and presenting the online games 115 to players. Example devices 120, 125 include mobile devices (e.g., laptops, smart phones, tablet computers, and so on), computing devices, set-top boxes, specialized gaming devices, and so on. The mobile devices 120, 125 may support and run various different operating systems, such as Microsoft® Windows®, Mac OS®, Google® Chrome®, Linux®, Unix®, or any other mobile operating system, including Symbian®, Palm®, Windows Mobile®, Google® Android®, Mobile Linux®, and so on.

At any given time, the game server may support, provide, and/or run multiple game instances 117 of an online game 115. A game instance 117 may relate to a single session or game play for one or more players at the mobile devices 120, 125. For example, a game instance 117 may be a single instance or session of the online game 115 that is played via a player at mobile device 120, such as a single game that is played until a player completes all stages of the game and/or reaches an end game status (e.g., a zero lives status) before completing the stages of the game.

The game server 110 includes various databases, such as a player database 140, that store information and data associated with the online games 115, the game instances 117, and the players of the online games 115. For example, the player database 140 may include information identifying the players (e.g., biographical information), information identifying the devices 120, 125 used by the players (e.g., a unique address for the device 120), game play characteristics for the players (e.g., points, levels, or stages achieved within the online games 115, rewards provided to the players, and so on), information identifying the connections between players (e.g., friend lists that identify associations between players), and so on.

In some embodiments, the game server 110 may communicate with other network resources. For example, the game server 110 may communicate with a social network service 160 or other online communities (e.g., microblogs, membership communities, and so on), in order to identify connections and other relationships between players of the online games 115 and/or recruit new players to the online games 115 (e.g., by posting advertisements and/or other messages to feeds and/or timelines provided by the online communities).

In some embodiments, the game server 110 includes a game collaboration system 150 that facilitates the collaboration of players in the online games 115. As described herein, the game collaboration system 150 may determine a player has reached an end game status (e.g., has zero lives or no game currency) while playing a game instance of an online game, identify and/or select another player of the online game (e.g., another player who is a friend of the player), and insert or otherwise enable the other player to access the online game within the game instance of the player, such as at a stage where the player reached the end game status). Further details regarding the components and methods performed by the game collaboration system 150 are described herein.

### Examples of the Online Game

The game server 110 may provide a variety of different online games 115 and/or types of online games 115. For example, the game server 110 may provide progression games, such as games where players progress or move from one stage to another by completing quests, solving puzzles, or performing other tasks. The game server 110 may also provide other games, such as sports games, first person shooter games, massive multiplayer games, strategy games, and so on.

For example, the game server 110 may provide an online game 115 where a player controls a character and progresses through the game by flying or jumping to higher altitudes within the game environment. In order to progress through the game (e.g., go high or reach a higher altitude) the player may overcome obstacles within the game environment and/or attack and vanquish enemy characters within the game environment.

The player may select multiple different characters (e.g., three of many available characters) via which the player navigates the game. For example, the player may select a tiger, panda, and rabbit as his/her game play characters, from a collection of many different character types. The characters may have various inherent or associated game play points or characteristics, such as attack points, hit or health points, jump or movement points, and so on. The player may use one character to play the game and attempt to reach higher altitudes, or may switch between characters, depending on the obstacles or enemy characters faces within the game environment. The player may provision game objects to characters as described in the application entitled, “Automatically Provisioning Game Objects to Characters in Online Games”, which is assigned to the same assignee and filed on the same date as the present application, which is incorporated by reference.

At various stages within the game, such as at certain height levels reached by the player, the online game may reward the player with gear or other virtual objects which enhance the characteristics of the characters used by the player. For example, upon reaching a first height achievement level, the game may reward the player with a weapon that gives the character enhanced attack points, armor that gives the character enhanced health or hit points, and/or clothing that gives the character enhanced movement or jump points, among other things. The provided gear or other virtual objects may be specific to the characters (e.g., a frog character receives a frying pan as a weapon, whereas a dog character receives a bazooka), and/or may have varying rarity (and, therefore, varying enhancement values).

Of course, the game server 110 may provide other online games and/or game types to the players at the mobile devices 120, 125.

Examples of Facilitating the Collaboration of Players within an Online Game

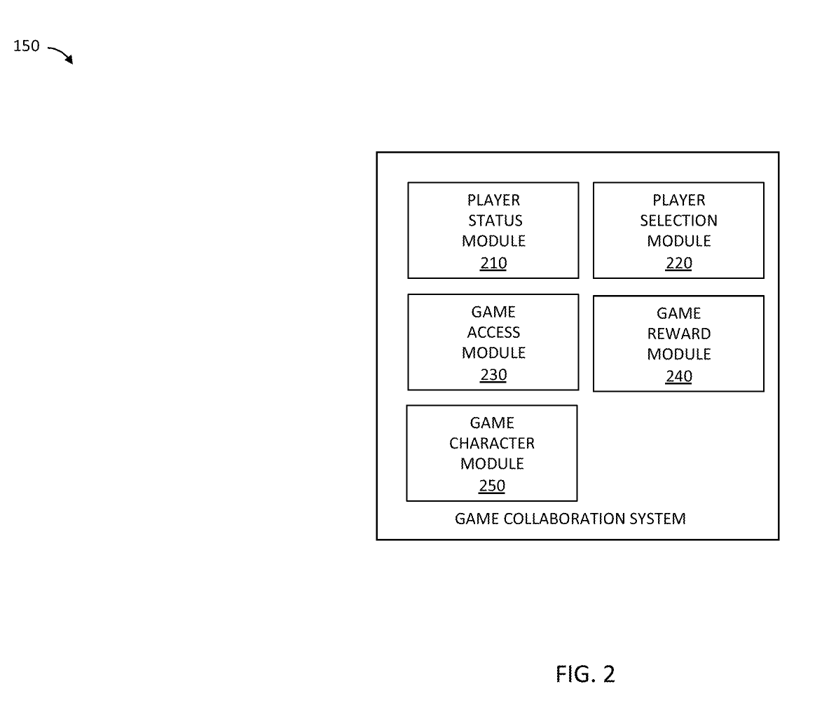

As described herein, in some embodiments, the game collaboration system 150 includes components that facilitate the collaboration of players within an online game. FIG. 2 is a block diagram illustrating the components of the game collaboration system 150. The game collaboration system 150 may include one or more modules and/or components to perform one or more operations of the game collaboration system 150. The modules may be hardware, software, or a combination of hardware and software, and may be executed by one or more processors. For example, the game collaboration system 150 may include a player status module 210, a player selection module 220, a game access module 230, a game reward module 240, and a game character module 250.

In some embodiments, the player status module 210 is configured and/or programmed to determine a first player of an online game has reached a zero lives status within a game instance of the online game. For example, the player status module 210 determines a player of a currently played game instance has reached an end game status or other status where the player can no longer (or, is not allowed to) play the currently played game instance. Example end game statuses include: a zero lives status where the player no longer has any lives within the game with which to play the game (e.g., a quest or progression game, such as the example game described herein), a zero currency or points status where the player no longer has currency or points with which to play the game (e.g., an online casino game or quiz game), a success status where the player has completed the game or completed the stages or levels available to the player (e.g., the player has completed all available stages of a free version of a game), and so on.

In some embodiments, the player selection module 220 is configured and/or programmed to select a second player of the online game according to a predetermined selection criteria. The player selection module 220 may apply various selection criteria and/or perform different processes when selecting a second player to collaborate with the first player in playing a game instance.

For example, the player selection module 220 may identify a member of the social network service 160 that includes the first player as a member, send a request to the identified member to play the game instance of the online game on behalf of the first player, and upon receiving an indication that the request was accepted by the member of the social network service, select the member as the second player of the game instance of the online game. The player selection module 220, therefore, may select another player that is a friend of the first player within the social network service 160 (e.g., Facebook, Google+, Twitter, LinkedIn, and so on) as the second player.

As another example, the player selection module 220 may identify another player of the online game having game play characteristics (e.g., has previously complete the game instance or certain stages within the game instance) that satisfy the predetermined selection criteria, send a request to the identified member to play the game instance of the online game on behalf of the first player, and upon receiving an indication that the request was accepted by the member of the social network service, select the member as the second player of the game instance of the online game. The player selection module 220, therefore, may identify and/or automatically select another player of the online game, such as another player that is connected (e.g., on a friend list) to the first player within the online game, as the second player based on the player's previous game characteristics, history, relationship to the first player, and/or other characteristics or attributes.

In some embodiments, the game access module 230 is configured and/or programmed to provide the second player with access to the game instance of the online game at a stage within the game instance that corresponds to a stage at which the first player reached the zero lives status. For example, the game access module 230 enables the second player to take over the game instance from the first player and continue to play the game instance on behalf of the first player.

The game access module 230 may provide the second player with access to the game instance in a variety of ways. For example, when the first player accesses the online game 115 using the mobile device 120 and the second player accesses the online game 115 using the mobile device 125, the game access module 230 may command the game server 110 to stop providing the game instance to the first player at the mobile device 120 and begin providing the game instance to the second player at the mobile device 125. As another example, the game access module 230 may enable both mobile devices to view the game instance, but only allow input received from the second player via the mobile device 125 to control the actions of the character within the game instance (the first player may watch via the mobile device 120).

In some embodiments, the game access module 230 may switch access and/or control of the game instance within a certain time period. For example, the game access module 230 may allow the second player access to the game instance when the second player was selected within a certain time period after the first player reached the zero lives status (e.g., within 1 or 5 minutes after the first player died within the game instance).

In some embodiments, the game reward module 240 is configured and/or programmed to provide rewards to the first player and/or the second player based on actions performed by the second player after taking over the game instance from the first player. For example, the game reward module 240 may determine that the second player of the game instance has completed a stage within the game instance not reached by the first player and provide a reward within the online game to the first player and the second player that is based on the completion of the stage by the second player. As another example, the game reward module 240 may determine that the second player has completed the stage at which the first player reached the zero lives status and provide the first player with a reward to continue playing the game instance at the stage at which the first player reached the zero lives status.

In some embodiments, the game character module 250 is configured and/or programmed to identify a character used by the first player when playing the game instance of the online game and assign the identified character used by the first player to the second player for use in the game instance of the online game. For example, the game character module 250 may enable the second player to assume one or more characters (and any gear or other characteristics) earned or selected by the first player when playing the game instance on behalf of the first player.

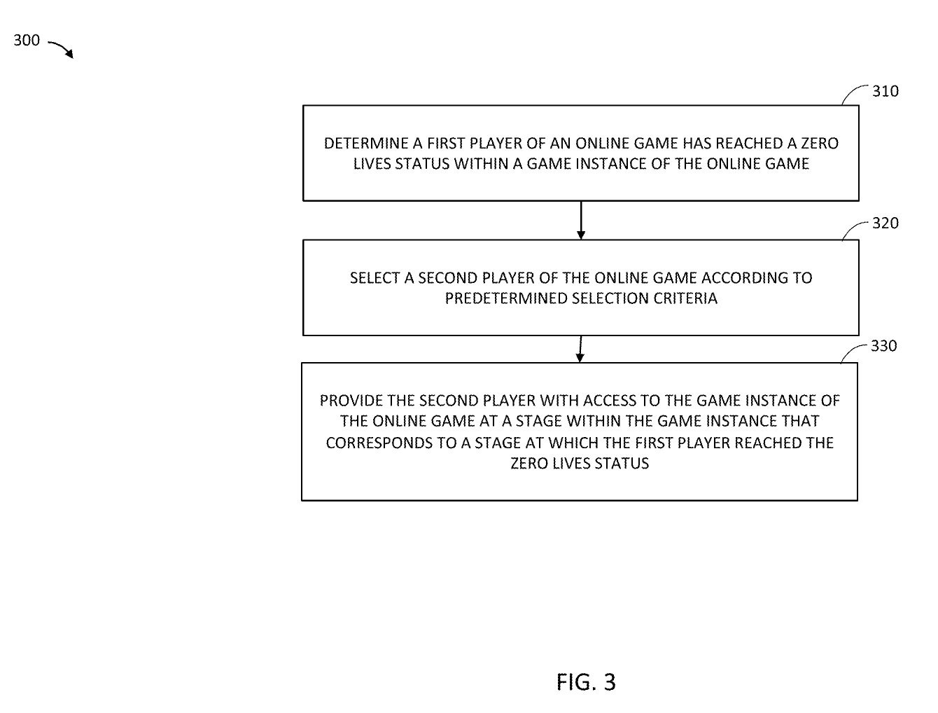

As described herein, the game collaboration system 150 may perform various different methods and algorithmic processes when enabling one player of an online game to take over a game instance originated by another player of the online game. FIG. 3 is a flow diagram illustrating a method 300 for providing a second player of an online game with access to a game instance of a first player of the online game. The method 300 may be performed by the game collaboration system 150 and, accordingly, is described herein merely by way of reference thereto. It will be appreciated that the method 300 may be performed on any suitable hardware.

In operation 310, the game collaboration system 150 determines a first player of an online game has reached a zero lives status within a game instance of the online game. For example, the player status module 210 determines a player of a currently played game instance has reached an end game status or other status where the player can no longer (or, is not allowed to) play the currently played game instance. Example end game statuses include: a zero lives status where the player no longer has any lives within the game with which to play the game (e.g., a quest or progression game, such as the example game described herein), a zero currency or points status where the player no longer has currency or points with which to play the game (e.g., an online casino game or quiz game), a success status where the player has completed the game or completed the stages or levels available to the player (e.g., the player has completed all available stages of a free version of a game), and so on.

In operation 320, the game collaboration system 150 selects a second player of the online game according to predetermined selection criteria. For example, as described herein, the player selection module 220 may apply various selection criteria and/or perform different processes when selecting a second player to collaborate with the first player in playing a game instance.

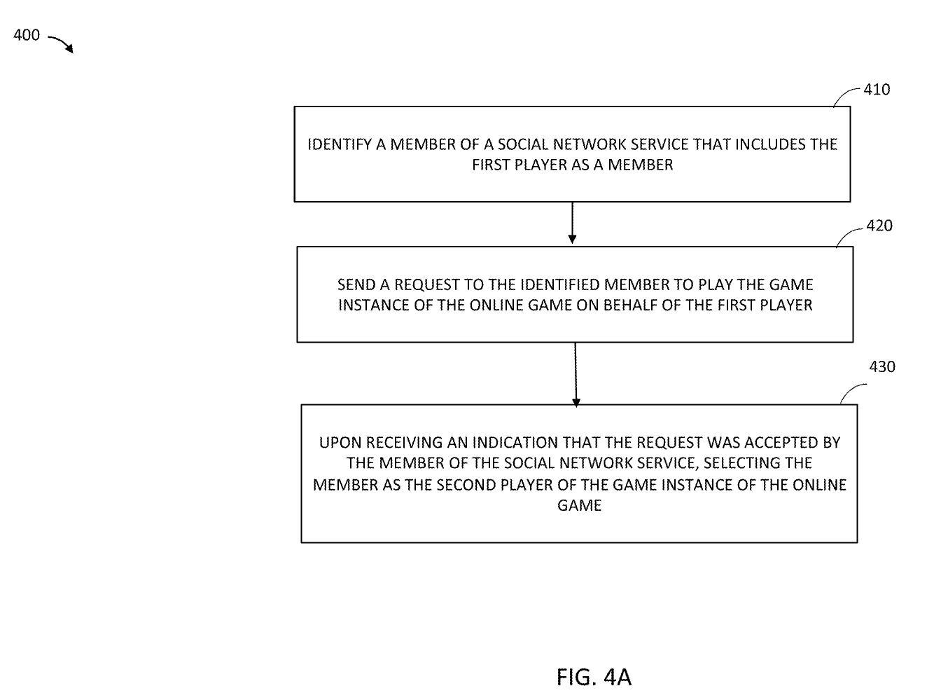

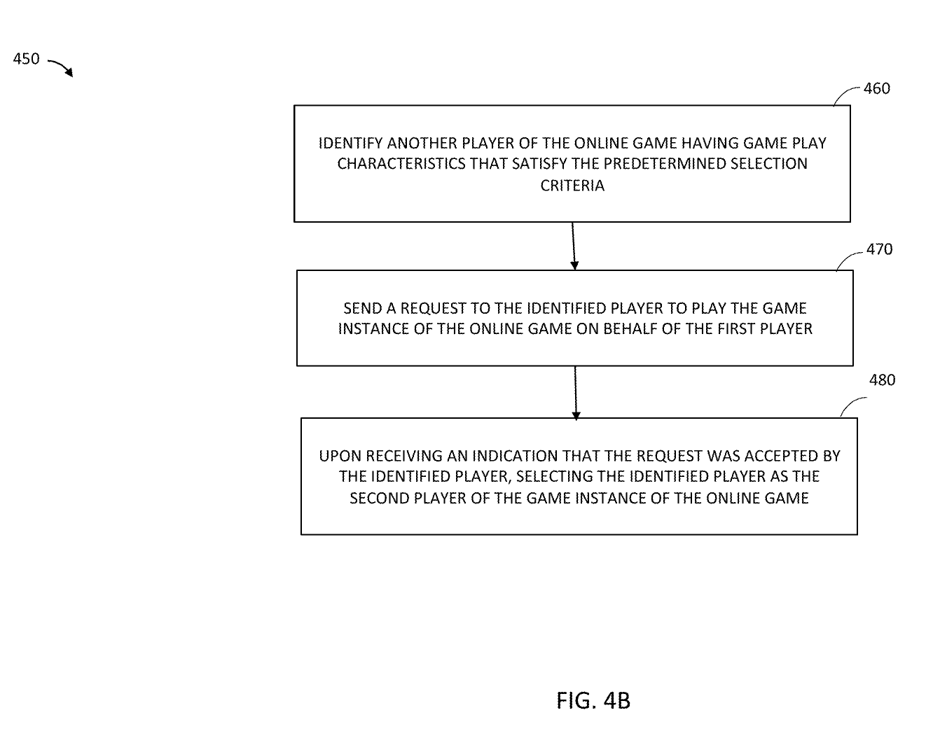

FIG. 4A depicts a method 400 for selecting a member of a social network as a collaborator. The method 400 may be performed by the game collaboration system 150 and, accordingly, is described herein merely by way of reference thereto. It will be appreciated that the method 400 may be performed on any suitable hardware.

In operation 410, the game collaboration system 150 identifies a member of the social network service 160 that includes the first player as a member. For example, the game collaboration system 150 may access a friend list, database, or other information that indicate other members of the social network service 160 that are connected to or otherwise associated with the first player. As described herein, the social network service 160 may be an online community of users, a cohort or game players, and so on.

In operation 420, the game collaboration system 150 sends a request to the identified member to play the game instance of the online game on behalf of the first player. For example, the game collaboration system 150 may send a message to the second player that is displayed within the online game 115 or within a messaging application provided by the online game, may post a message to a feed or member page provided by the social network service 160, may send a text message, instant message, or other direct communication to the member, and so on, when sending the request.

In operation 430, the game collaboration system 150, upon receiving an indication that the request was accepted by the member of the social network service, selects the member as the second player of the game instance of the online game.

FIG. 4B is a flow diagram illustrating a method 450 for selecting another player of an online game as a collaborator. The method 450 may be performed by the game collaboration system 150 and, accordingly, is described herein merely by way of reference thereto. It will be appreciated that the method 450 may be performed on any suitable hardware.

In operation 460, the game collaboration system 150 identifies another player of the online game having game play characteristics that satisfy the predetermined selection criteria. For example, the game collaboration system 150 may identify another player that has previously completed some or all stages of the online game (e.g., the stage at which the first player lost his/her remaining life), another player that also has not yet completed the stage at which the first player stopped playing the game, another player that is a friend or otherwise connected to the first player, another player that has not played the online game for a threshold number of days, another player that was previously or currently selected by the first player, another player that shares common attributes (e.g., skill level, interests, location, and so on) with the first player, and so on.

The game collaboration system 150, for example, may receive input from the first player that identifies a friend within the online game as a potential collaborator in the game instance, and send a request to the identified friend to play the game instance of the online game on behalf of the first player. However, as another example, the game collaboration system 150 may automatically send a request to another player of the online game to play the game instance of the online game on behalf of the first player, and upon receiving an indication that the request was accepted by the identified friend within a certain time period, select the friend as the second player of the game instance of the online game.

In operation 470, the game collaboration system 150 sends a request to the identified member to play the game instance of the online game on behalf of the first player. For example, the game collaboration system 150 may send a message to the second player that is displayed within the online game 115 or within a messaging application provided by the online game, may send a text message, instant message, or other direct communication to the member, and so on, when sending the request.

In operation 480, the game collaboration system 150, upon receiving an indication that the request was accepted by the member of the social network service, selects the member as the second player of the game instance of the online game.

Referring back to FIG. 3, the game collaboration system 150, in operation 330, provides the second player with access to the game instance of the online game at a stage within the game instance that corresponds to a stage at which the first player reached the zero lives status. For example, when the first player accesses the online game 115 using the mobile device 120 and the second player accesses the online game 115 using the mobile device 125, the game access module 230 may command the game server 110 to stop providing the game instance to the first player at the mobile device 120 and begin providing the game instance to the second player at the mobile device 125. As another example, the game access module 230 may enable both mobile devices to view the game instance, but only allow input received from the second player via the mobile device 125 to control the actions of the character within the game instance (the first player may watch via the mobile device 120). In other words, the game collaboration system 150 may replace the first player with the second player at the stage at which the first player reached the zero lives status.

In some embodiments, the game access module 230 may switch access and/or control of the game instance within a certain time period. For example, the game access module 230 may allow the second player access to the game instance when the second player was selected within a certain time period after the first player reached the zero lives status (e.g., within 1 or 5 minutes after the first player died within the game instance).

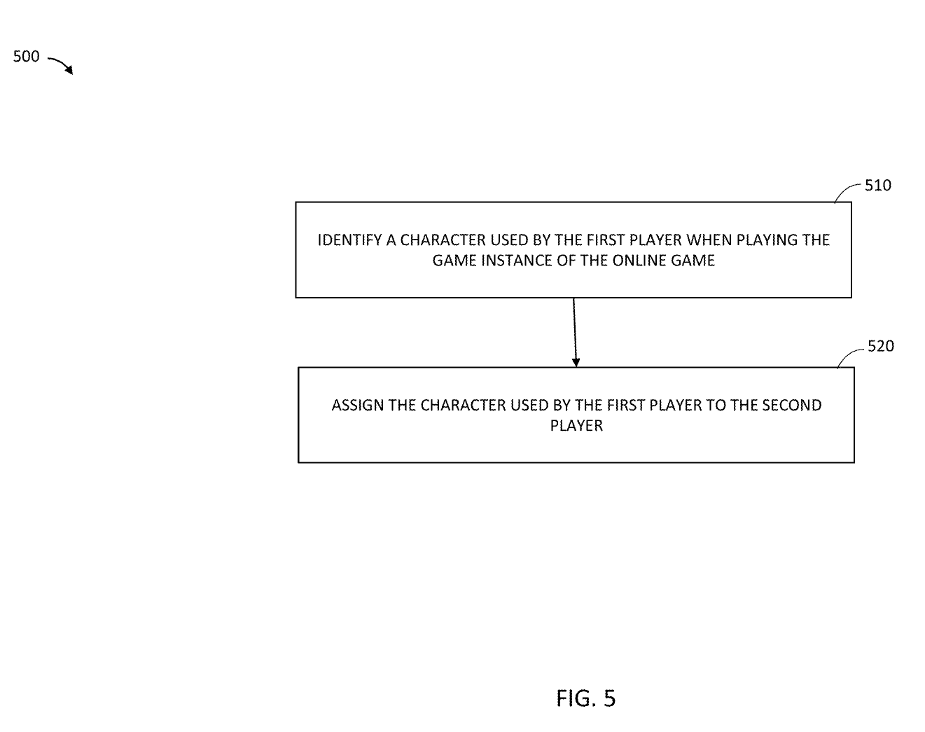

As described herein, the game collaboration system 150, in some embodiments, may assign characters to the players when they play the online game, including characters assigned to one or both of the collaborators (e.g., the first player and the second player) of a game instance. FIG. 5 depicts a method 500 for providing a character to be used by a collaborator in an online game. The method 500 may be performed by the game collaboration system 150 and, accordingly, is described herein merely by way of reference thereto. It will be appreciated that the method 500 may be performed on any suitable hardware.

In operation 510, the game collaboration system 150 identifies a character (and, associated gear) used by the first player when playing the game instance of the online game, and in operation 520, assigns the identified character (and, associated gear) used by the first player to the second player for use in the game instance of the online game. For example, the game collaboration system 150 may identify or otherwise determine that the first player uses the tiger and the dog when playing the online game, and in response to input received from the second player, assign the tiger and the dog to the second player (who has never previously used the tiger or the dog) when the second player assumes control of the game instance from the first player. However, the game collaboration system 150 may also allow the second player to utilized previous used characters.

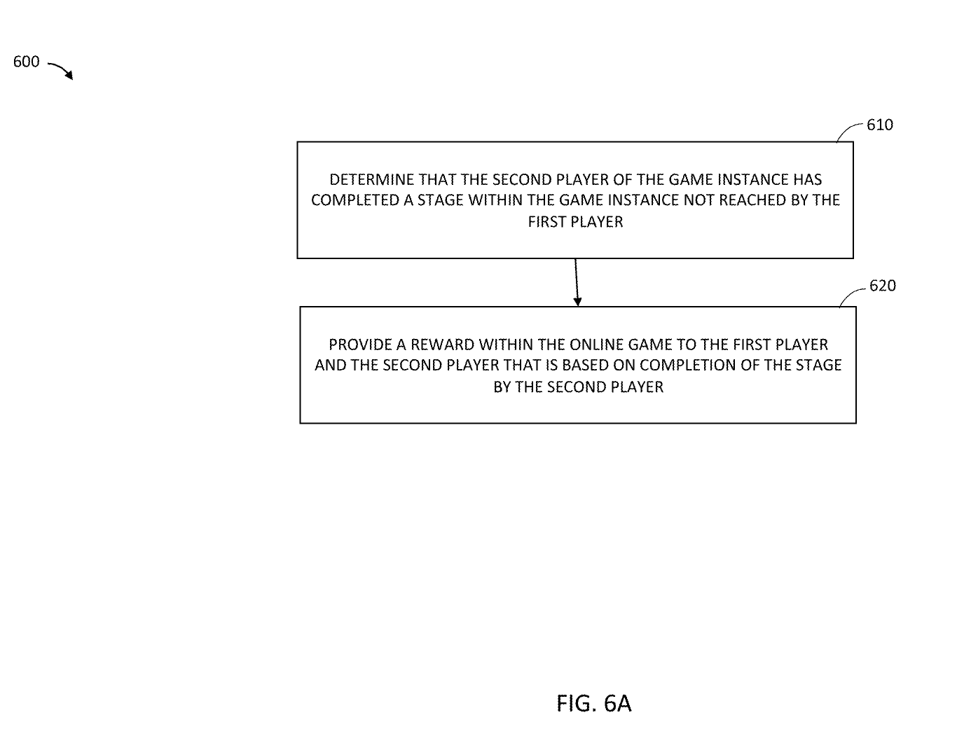

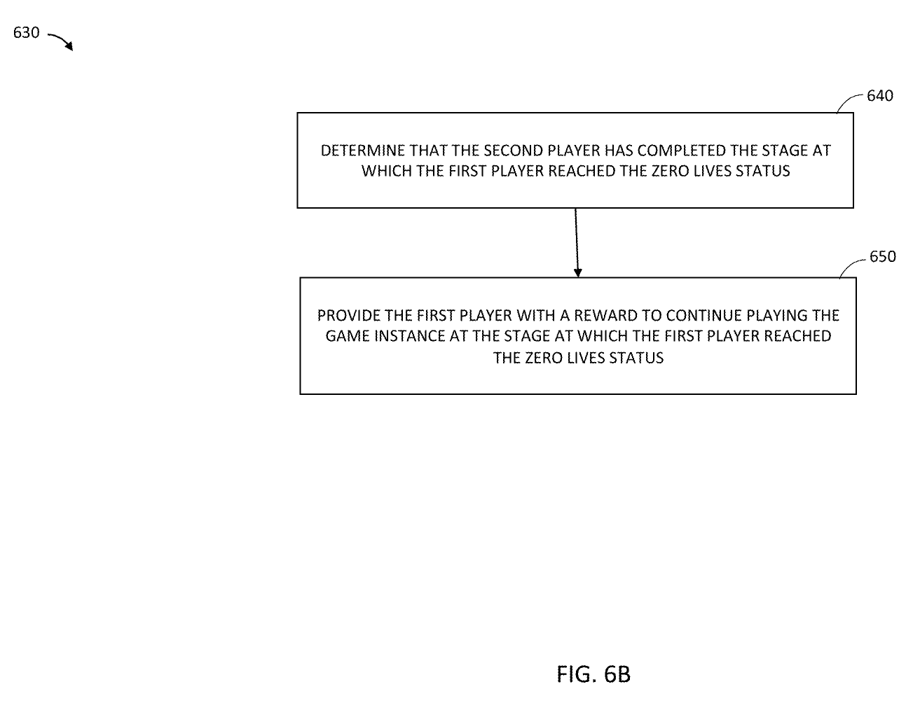

As described herein, the game collaboration system 150, in some embodiments, provides rewards to collaborators of online games. FIGS. 6A-6B depict methods 600, 630 for providing rewards to the players. The methods 600, 630 may be performed by the game collaboration system 150 and, accordingly, is described herein merely by way of reference thereto. It will be appreciated that the methods 600, 630 may be performed on any suitable hardware.

For example, FIG. 6A depicts a method 600 for rewarding the collaborators, or both players, of an online game. In operation 610, the game collaboration system 150 determines that the second player of the game instance has completed a stage within the game instance not reached by the first player, and, in operation 620, provides a reward within the online game to the first player and the second player that is based on the completion of the stage by the second player.

The game collaboration system 150 may provide various different rewards. For example, the game collaboration system 150 may provide the players with additional gear, additional characters, additional lives, in game currency or points, unlock codes or access to special or reserved stages or levels, and so on.

As another example, FIG. 6B depicts a method 630 for rewarding the first player based on the progress or achievements of the second player. In operation 640, the game collaboration system 150 determines that the second player has completed the stage at which the first player reached the zero lives status, and, in operation 650, provides the first player with a reward to continue playing the game instance at the stage at which the first player reached the zero lives status.

Thus, in some embodiments, the game collaboration system 150 determines that a player of an online game has reached an end game status within a game instance of the online game, identifies a friend of the player within the online game that has played a previous instance of the online game, and provides the friend with access to the game instance of the online game at a stage corresponding to a stage at which the player reached the end game status within the game instance. In other words, the game collaboration system 150 enables an online game 150 (or, the game provider) to encourage players to play with others in order to complete tasks or quests in the online game and reach certain stages, levels, or other achievable milestones.

Using the example game described herein, the game collaboration system 150 may facilitate and/or enable the following game play scenario:

A first player is playing a game instance of the online game (e.g., a game where the player attempts to reach a high altitude) using a frog character via the mobile device 120. The first player reaches an initial stage achievement (e.g., the 100 meter level), and the frog character representing the first player is assigned a frying pan as a weapon. The first player continues to play, and reaches a middle stage of 175 meters, before dying in a battle with an enemy and reaching a zero lives status. At this point, the online game, via the game collaboration system 150, selects a friend of the first player to be the second player, and enables the second player, via the mobile device 125, to access the game instance of the online game at the 175 meters stage. The online game enables input at the mobile device 125 to control the game instance, and the second player (while the first player watches via the mobile device 120). The second player, who assumed the frog character previously used by the first player, kills the enemy and reaches the 200-meter level achievement. The online game rewards both players with additional gear for the frog character, and the players continue playing the online game.

### Examples of Communication and Computing Systems

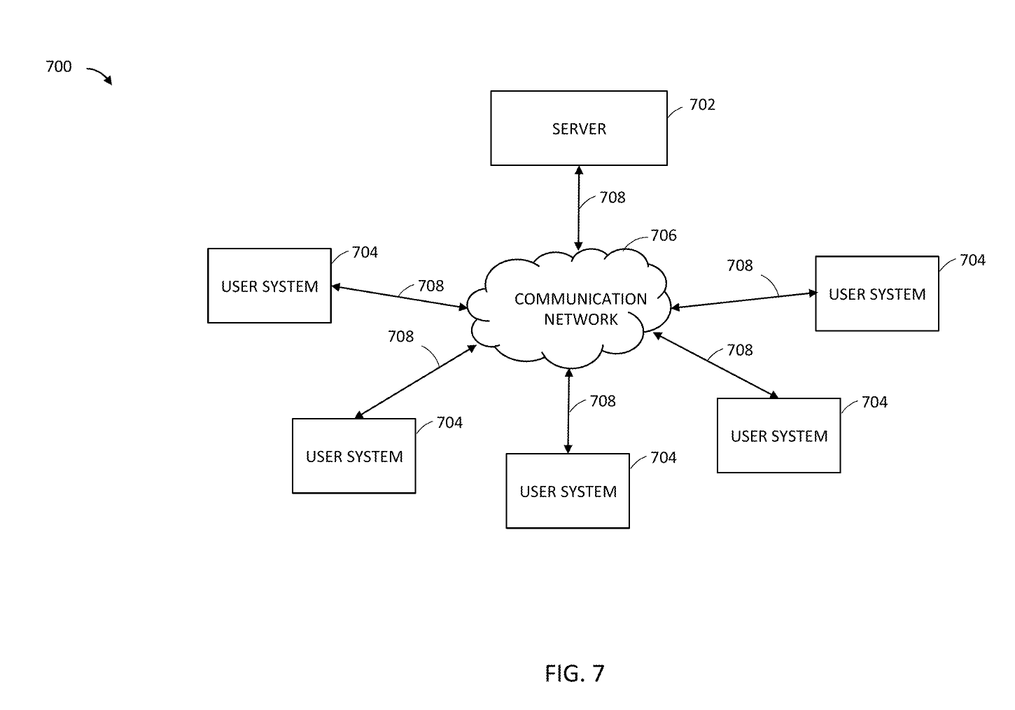

FIG. 7 shows a simplified view of a communications system 1000. The communication system 700 comprises a server 702, which is in communication with a communications network 706 via a communications link 708. A plurality of user systems 704 are in communication with the communications network via links 708, and can download games and other information from the server 702. Server 702 may provide the backend support for playing the video or online games. Server 702 also enables the user systems to download the game, send alerts or messages to the user systems and provide updates to the game.

User systems 704 may be smart phones, tablets, laptops, all-in-one computers, or any other computing device that is suitable for playing video or online games. The user system 704 should have a screen to display the video and an input device to input commands. Both of these functionalities can be provided by a touchscreen. Communication links 708 may be of the wired or wireless variety. Similarly, the communications network itself may comprise wired and/or wireless components.

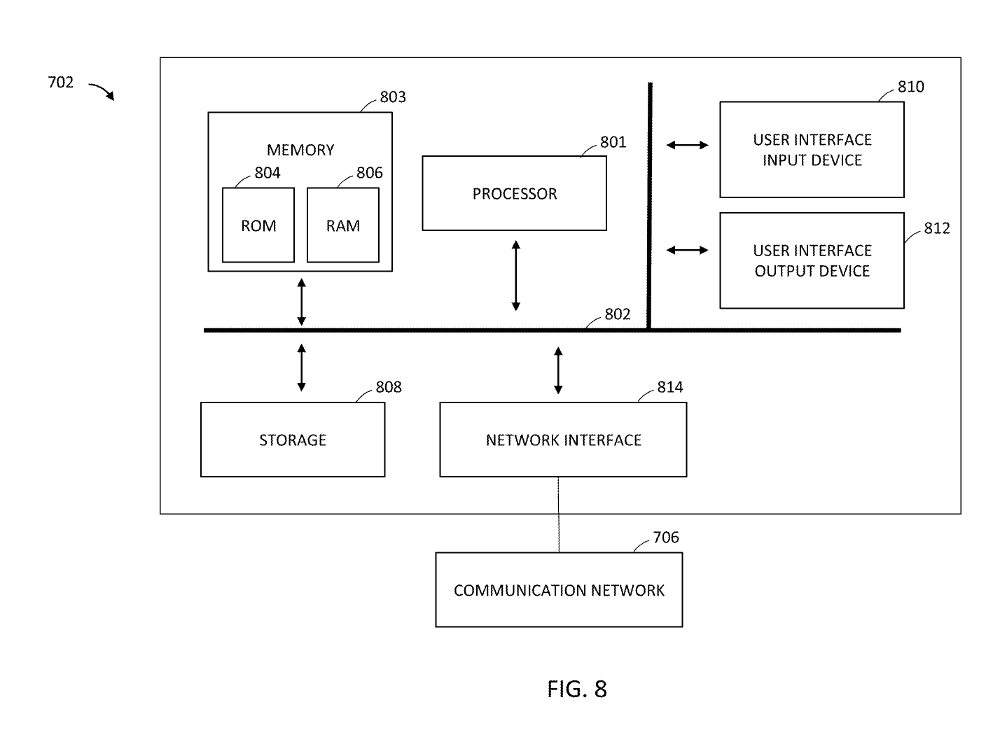

FIG. 8 shows a simplified view of components in server 702 in FIG. 7. Server 702 comprises a processor or CPU 801 that is in communication with a variety of other elements via a bus 802. Such other components of the server include, but are not limited to, a non-transitory computer readable storage medium as a memory 803, including a Read Only Memory (ROM) 804 and a Random Access Memory (RAM) 806, and also a higher capacity non-transitory computer readable storage medium 808. One or more of these elements may be employed by the server to store the computer code representing the instructions for operating the video game. This computer code may be sent from the server over the communication network to a user device, to allow a user to download the video game.

An administrator or other authorized personnel may communicate with the server via a user interface input device 810 (e.g. a keyboard, mouse), for example to update or modify the code being disseminated to the various user devices. The administrator or other authorized personnel may receive information from the server via a user interface output device 812 such as a display screen. This received information may comprise user registrations and/or subscriptions.

Server 702 includes a network interface 814 that is configured to allow information to be communicated between the server and the communications network. An example of such information is the computer code that is executable on the user system to run the video game. Although FIG. 8 illustrates the components of server 702, some of user systems 704 may have the same or similar components thereto.

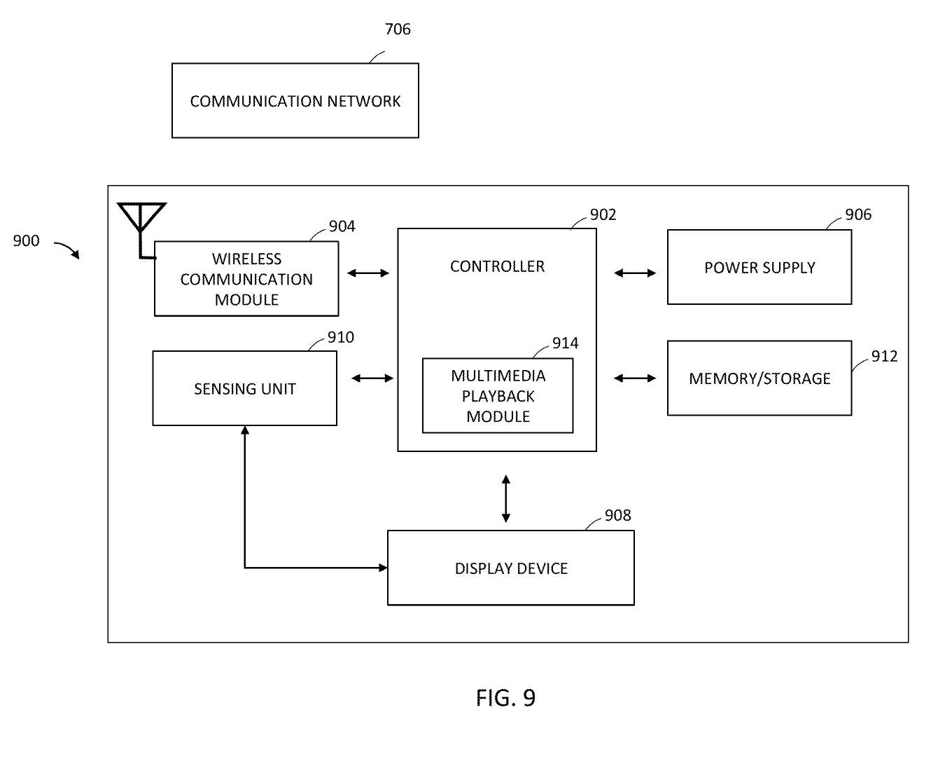

FIG. 9 shows a simplified view of a user device 900 (e.g., mobile device 120 or 125), which is a type of user system 704. User device 900 may be a smart phone or tablet and includes a controller 902 for controlling the operation of the user device, a wireless communication module 904 for communicating with a network, a power supply 906, a display device 908, a sensing unit 910, and a memory/storage unit 912.

Wireless communications module 906 is used to communicate with a wireless network and receive or stream a video game from server 702. The video game or data file received from the server is stored in the memory/storage unit 912 using controller 902. The video game comprises computer code for executing various steps needed to play the video game. In some embodiments, once the game is downloaded to the storage unit, the user device can play the game without being connected to server 702. Alternatively, the game may require user device 900 to remain in communication with server 702 to play the game, or at least receive a key or a portion of the video game each time the user wishes to launch the game.

The video or online game is launched and played using a multimedia playback module 914. The video game is displayed on display device 908 (e.g., a touchscreen) that can also receive inputs from a user. Sensing unit 910 senses inputs made on the touchscreen, including the swiping motions and amounts of downward force exerted thereon. Controller 902 determines a direction and distance based on the input sensed by the sensing unit.

Having thus described embodiments of the present technology, it should be noted by those skilled in the art that the disclosures within are exemplary only, and that various other alternatives, adaptations, and modifications are possible. Accordingly, embodiments are not limited to the specific structures or methods as illustrated and taught herein.

What is claimed is:

1. A method performed by an online game, the method comprising:
determining a first player of the online game has reached a zero lives status within a game instance of the online game;
selecting a second player of the online game according to predetermined selection criteria; and
providing the second player with access to the game instance of the online game at a stage within the game instance that corresponds to a stage at which the first player reached the zero lives status.

2. The method of claim 1, further comprising:
identifying a character used by the first player when playing the game instance of the online game; and
assigning the identified character used by the first player to the second player for use in the game instance of the online game.

3. The method of claim 1, further comprising:
identifying a character used by the second player when playing a previous game instance of the online game; and
assigning the identified character used by the second player when playing the previous game instance to the second player for use in the game instance of the online game.

4. The method of claim 1, wherein selecting a second player of the online game according to a predetermined selection criteria includes:
identifying a member of a social network service that includes the first player as a member;
sending a request to the identified member to play the game instance of the online game on behalf of the first player; and
upon receiving an indication that the request was accepted by the member of the social network service, selecting the member as the second player of the game instance of the online game.

5. The method of claim 1, wherein selecting a second player of the online game according to a predetermined selection criteria includes:
identifying another player of the online game having game play characteristics that satisfy the predetermined selection criteria;
sending a request to the identified member to play the game instance of the online game on behalf of the first player; and
upon receiving an indication that the request was accepted by the member of the social network service, selecting the member as the second player of the game instance of the online game.

6. The method of claim 1, wherein providing the second player with access to the game instance of the online game at a stage within the game instance that corresponds to a stage at which the first player reached the zero lives status includes providing the second player with access to the game instance when the second player was selected within a time period after the first player reached the zero lives status.

7. The method of claim 1, further comprising:
determining that the second player of the game instance has completed a stage within the game instance not reached by the first player; and
providing a reward within the online game to the first player and the second player that is based on the completion of the stage by the second player.

8. The method of claim 1, further comprising:
determining that the second player has completed the stage at which the first player reached the zero lives status; and
providing the first player with a reward to continue playing the game instance at the stage at which the first player reached the zero lives status.

9. The method of claim 1, wherein selecting a second player of the online game according to a predetermined selection criteria includes:
receiving input from the first player that identifies a friend within the online game as a potential collaborator in the game instance;
sending a request to the identified friend to play the game instance of the online game on behalf of the first player; and
upon receiving an indication that the request was accepted by the identified friend within a certain time period, selecting the friend as the second player of the game instance of the online game.

10. The method of claim 1, wherein selecting a second player of the online game according to a predetermined selection criteria includes:
automatically sending a request to another player of the online game to play the game instance of the online game on behalf of the first player; and
upon receiving an indication that the request was accepted by the identified friend within a certain time period, selecting the friend as the second player of the game instance of the online game.

11. A system, comprising:
a player status module that determines a first player of the online game has reached a zero lives status within a game instance of the online game;
a player selection module that selects a second player of the online game according to predetermined selection criteria; and
a game access module that provides the second player with access to the game instance of the online game at a stage within the game instance that corresponds to a stage at which the first player reached the zero lives status.

12. The system of claim 11, further comprising:
a game character module that identifies a character used by the first player when playing the game instance of the online game and assigns the identified character used by the first player to the second player for use in the game instance of the online game.

13. The system of claim 11, further comprising:
a game character module that identifies a character used by the second player when playing a previous game instance of the online game and assigns the identified character used by the second player when playing the previous game instance to the second player for use in the game instance of the online game.

14. The system of claim 11, wherein the player selection module:
identifies a member of a social network service that includes the first player as a member;
sends a request to the identified member to play the game instance of the online game on behalf of the first player; and
upon receiving an indication that the request was accepted by the member of the social network service, selects the member as the second player of the game instance of the online game.

15. The system of claim 11, wherein the player selection module:
identifies another player of the online game having game play characteristics that satisfy the predetermined selection criteria;
sends a request to the identified member to play the game instance of the online game on behalf of the first player; and
upon receiving an indication that the request was accepted by the member of the social network service, selects the member as the second player of the game instance of the online game.

16. The system of claim 11, wherein the game access module provides the second player with access to the game instance when the second player was selected within a time period after the first player reached the zero lives status.

17. The system of claim 11, further comprising:
a game reward module that determines that the second player of the game instance has completed a stage within the game instance not reached by the first player and provides a reward within the online game to the first player and the second player that is based on the completion of the stage by the second player.

18. A computer-readable storage medium whose contents, when executed by an online game, cause the online game to perform operations, the operations comprising:
determining that a player of an online game has reached an end game status within a game instance of the online game;
identifying a friend of the player within the online game that has played a previous instance of the online game; and
providing the friend with access to the game instance of the online game at a stage corresponding to a stage at which the player reached the end game status within the game instance.

19. The computer-readable storage medium of claim 18, further comprising:
providing the friend with a character and associated gear that was assigned to the player during the game instance of the online game.
